(19) United States
(12) Patent Application Publication
(10) Pub. No.: US 2007/0283431 A1
(43) Pub. Date: Dec. 6, 2007

(54) Information processing apparatus and authentication control method

(75) Inventor: KUNIO UEDA, Ome-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/785,497

(22) Filed: Apr. 18, 2007

(30) Foreign Application Priority Data
Apr. 27, 2006 (JP) 2006-123857

(51) Int. Cl. H04L 9/32

(52) U.S. Cl. 726/19; 726/17

(57) ABSTRACT

According to one embodiment, an information processing apparatus includes a main body, a plurality of authentication units which execute a plurality of mutually different kinds of authentication processes, a time-measuring unit which measures an elapsed time from a time point of an end of last use of the main body to issuance of a request for use of the main body, and a use permission determination unit which determines whether a number of successfully completed authentication processes of the plural kinds of authentication processes has reached a predetermined number which varies in accordance with the elapsed time measured by the time-measuring unit, and permits the use of the main body when the number of successfully completed authentication processes has reached the predetermined number.

### CROSS-REFERENCE TO RELATED APPLICATIONS

This application is based upon and claims the benefit of priority from Japanese Patent Application No. 2006-123857, filed Apr. 27, 2006, the entire contents of which are incorporated herein by reference.

### BACKGROUND

1. Field

One embodiment of the invention relates to an information processing apparatus such as a personal computer, and more particularly to an information processing apparatus having a user authentication function, and an authentication control method for use in the apparatus.

2. Description of the Related Art

In recent years, various types of portable personal computers, such as laptop personal computers and notebook personal computers, have been developed. These portable computers have security functions for preventing unlawful use of the computers.

As a representative security function, there is known a user authentication function for confirming the authenticity of the user.

Jpn. Pat. Appln. KOKAI Publication No. 2003-122443 discloses an electronic apparatus having a user authentication function. This electronic apparatus has three kinds of authentication functions. One of the three kinds of authentication functions is selected in accordance with an off-state cumulative time from a time point of the last power-off of the electronic apparatus to a time point of the present power-on of the electronic apparatus.

In the electronic apparatus of Jpn. Pat. Appln. KOKAI Publication No. 2003-122443, however, the number of authentication functions, which are used, is always one. It is thus difficult to realize a sufficiently high security level. If a plurality of authentication functions are always used, the security level would be increased but the usability would deteriorate.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a front-side external appearance of an information processing apparatus according to an embodiment of the invention;

FIG. 2 is an exemplary block diagram showing the system configuration of the information processing apparatus shown in FIG. 1;

FIG. 3 is an exemplary view for describing an authentication control function which is provided in the information processing apparatus shown in FIG. 1;

FIG. 4 is an exemplary flow chart for describing an example of a process procedure which is executed by an authentication request unit provided in the information processing apparatus shown in FIG. 1;

FIG. 5 is an exemplary flow chart for describing an example of a process procedure which is executed by a use permission determination unit provided in the information processing apparatus shown in FIG. 1; and

FIG. 6 is an exemplary flow chart for describing an example of a process procedure which is executed by an end-of-use notice unit provided in the information processing apparatus shown in FIG. 1.

### DETAILED DESCRIPTION

Various embodiments according to the invention will be described hereinafter with reference to the accompanying drawings. In general, according to one embodiment of the invention, an information processing apparatus includes a main body, a plurality of authentication units which execute a plurality of mutually different kinds of authentication processes, a time-measuring unit which measures an elapsed time from a time point of an end of last use of the main body to issuance of a request for use of the main body, and a use permission determination unit which determines whether a number of successfully completed authentication processes of the plural kinds of authentication processes has reached a predetermined number which varies in accordance with the elapsed time measured by the time-measuring unit, and permits the use of the main body when the number of successfully completed authentication processes has reached the predetermined number.

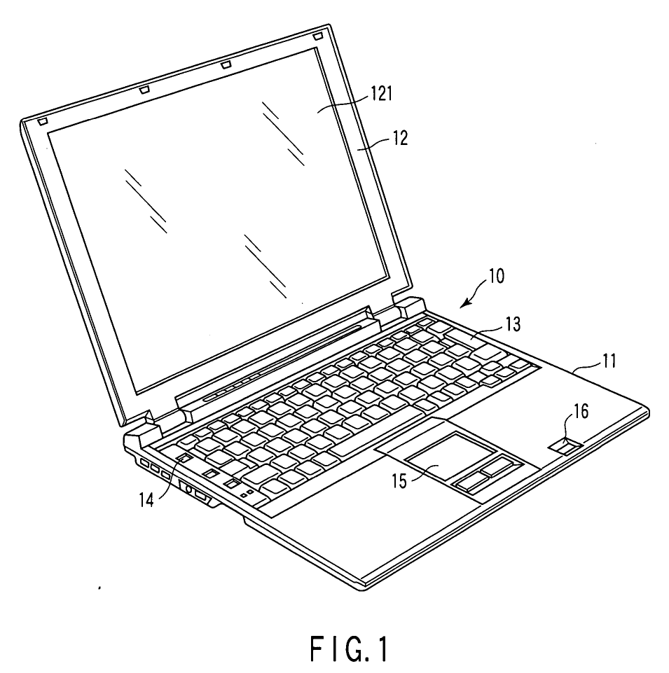

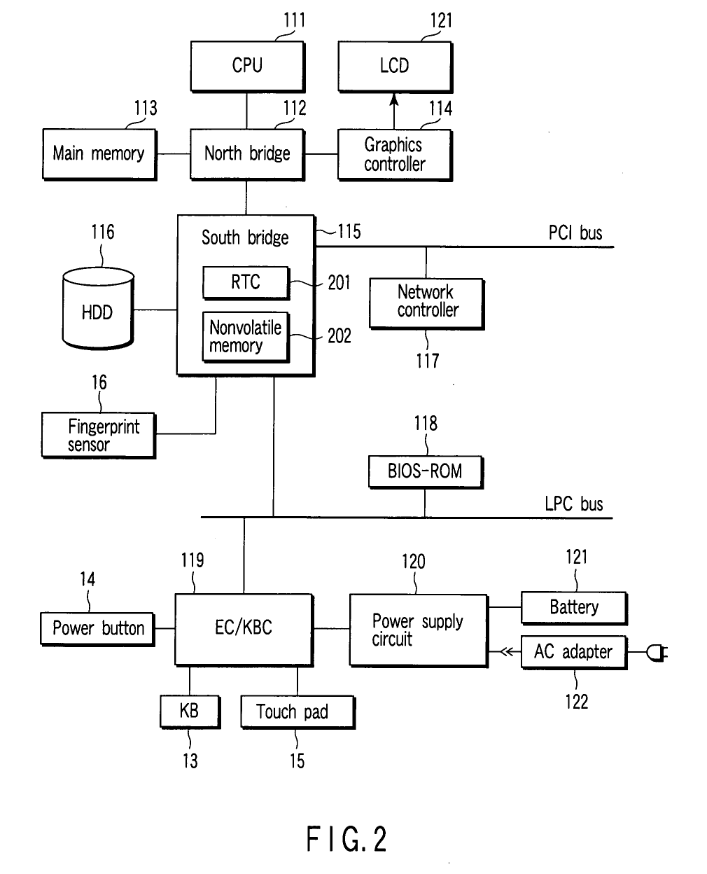

To begin with, referring to FIG. 1 and FIG. 2, the structure of an information processing apparatus according to the embodiment of the invention is described. The information processing apparatus is realized, for example, as a battery-powerable portable notebook personal computer 10.

FIG. 1 is a front-side perspective view of the computer 10 in the state in which a display unit of the personal computer 10 is opened.

The computer 10 comprises a main body (hereinafter referred to as “computer main body”) 11 and a display unit 12. A display device that is composed of an LCD (Liquid Crystal Display) 121 is built in the display unit 12. The display screen of the LCD 121 is positioned at an approximately central part of the display unit 12.

The display unit 12 is supported on the computer main body 11 such that the display unit 12 is freely rotatable, relative to the computer main body 11, between an open position in which the top surface of the computer main body 11 is exposed and a closed position in which the top surface of the computer main body 11 is covered. The computer main body 11 has a thin box-shaped casing. A keyboard 13, a power button 14 for powering on/off the computer 10 and a touch pad 15 are disposed on the top surface of the computer main body 11. Further, a fingerprint sensor 16 is disposed on the top surface of the computer main body 11. The fingerprint sensor 16 is a sensor for sensing the user's fingerprint.

FIG. 2 shows an example of the system configuration of the computer 10.

The computer 10 comprises a CPU 111, a north bridge 112, a main memory 113, a graphics controller 114, a south bridge 115, a hard disk drive (HDD) 116, a network controller 117, a flash BIOS-ROM 118, an embedded controller/keyboard controller IC (EC/KBC) 119, and a power supply circuit 120.

The CPU 111 is a processor that controls the operation of the components of the computer 10. The CPU 111 executes an operating system and various application programs/utility programs, which are loaded from the HDD 116 into the main memory 113. The CPU 111 also executes a BIOS (Basic Input/Output System) that is stored in the flash BIOS-ROM 118. The BIOS is a program for hardware control.

The north bridge 112 is a bridge device that connects a local bus of the CPU 111 and the south bridge 115. In addition, the north bridge 112 has a function of executing communication with the graphics controller 114 via, e.g. an AGP (Accelerated Graphics Port) bus. Further, the north bridge 112 includes a memory controller that controls the main memory 113.

The graphics controller 114 is a display controller which controls the LCD 121 that is used as a display monitor of the computer 10. The south bridge 115 is connected to a PCI (Peripheral Component Interconnect) bus and an LPC (Low Pin Count) bus.

The south bridge 115 incorporates a real time clock (RTC) 201 and a nonvolatile memory 202. The real time clock (RTC) 201 is a clock module which measures date and time. Even while the computer 10 is powered off, the real time clock (RTC) 201 is operated by a battery which is dedicated to the real time clock (RTC) 201.

The embedded controller/keyboard controller IC (EC/KBC) 119 is a 1-chip microcomputer in which an embedded controller for power management and a keyboard controller for controlling the keyboard (KB) 13 and touch pad 15 are integrated. The embedded controller/keyboard controller IC 119 cooperates with the power supply circuit 120 to power on/off the computer 10 in response to the user's operation of the power button switch 14. The power supply circuit 120 generates system power, which is to be supplied to the components of the computer 10, using power from a battery 121 or external power supplied from an AC adapter 122.

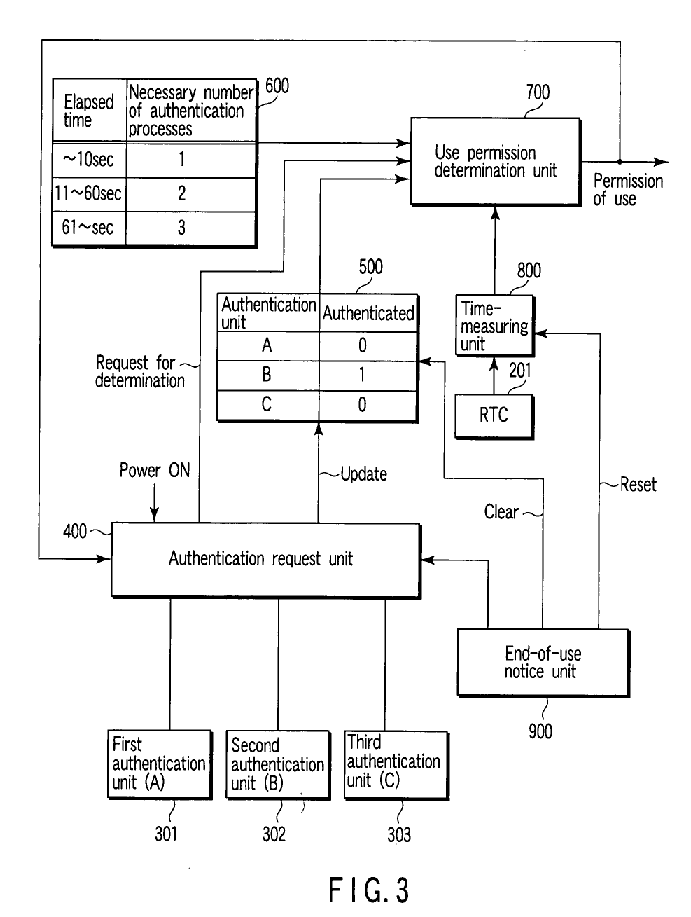

Next, referring to FIG. 3, an authentication function, which is provided in the computer 10, is described.

In the computer 10, an authentication control program is pre-installed. The authentication control program is built, for example, in the BIOS or operating system (OS). The authentication control program performs a process for restricting use of the computer 10.

FIG. 3 shows the functional structure of the authentication control program. Specifically, the authentication control program includes, as its functional modules, a first authentication unit (A) 301, a second authentication unit (B) 302, a third authentication unit (C) 303, an authentication request unit 400, an authentication state hold buffer 500, a necessary-number-of-authentication-processes table 600, a use permission determination unit 700, a time-measuring unit 800, and an end-of-use notice unit 900.

The first authentication unit (A) 301, second authentication unit (B) 302 and third authentication unit (C) 303 execute user authentication processes by mutually different kinds of authentication methods.

Specifically, the first authentication unit (A) 301 executes a first authentication process (A) for confirming the authenticity of the user. The first authentication process (A) is, for example, a password authentication process for verifying a password which is input by the user's typing operation through the keyboard 13. In the password authentication process, it is determined whether the password, which is input by the user's typing, agrees with a password which is prestored, for example, in the nonvolatile memory 202.

The second authentication unit (B) 302 executes a second authentication process (B) for confirming the authenticity of the user. The second authentication process (B) is, for example, a biometric authentication process for verifying the user's biometric information such as a fingerprint. In the biometric authentication process, it is determined, for example, whether the user's fingerprint, which is detected by the fingerprint sensor 16, agrees with a fingerprint which is prestored, for example, in the nonvolatile memory 202.

The third authentication unit (C) 303 executes a third authentication process (C) for confirming the authenticity of the user. The third authentication process (C) is, for example, a handwritten-signature authentication process using, e.g. a tablet. In the handwritten-signature authentication process, for example, a tablet having a coordinate detection function, which is disposed on the LCD 121, is used, and it is determined whether a signature (handwriting data), which is input by the user by handwriting on the tablet with use of a stylus, agrees with a signature (handwriting data) which is prestored, for example, in the nonvolatile memory 202. Needless to say, the user can execute handwriting-input, using an external tablet which is connectable to the computer 10.

The first authentication unit (A) 301, second authentication unit (B) 302 and third authentication unit (C) 303 are also usable for a logon authentication process. The logon authentication process is a process for determining whether the user is an authorized user who can log on to the operating system.

In addition, the first authentication unit (A) 301, second authentication unit (B) 302 and third authentication unit (C) 303 are also usable for a power-on authentication process. The power-on authentication process is a process for determining whether the user is a user who is authorized to boot up the operating system. The power-on authentication process is executed when the computer 10 is powered on. If the power-on authentication process is successfully completed, the user is permitted to boot up the operating system.

When the user has powered on the computer 10 or is to log on to the operating system, the user can attempt to execute an authentication procedure by using an arbitrary one or more of the first authentication unit (A) 301, second authentication unit (B) 302 and third authentication unit (C) 303. For example, if the user operates the keyboard 13, the first authentication process (A) is started. If the user puts his/her finger on the fingerprint sensor 16, the second authentication process (B) is started. If the user executes an input operation, for example, on the tablet, the third authentication process (C) is started.

Although the computer 10 has the three kinds of authentication units in this example, the number of kinds of authentication units is not limited.

The authentication request unit 400 executes overall management of the first authentication unit (A) 301, second authentication unit (B) 302 and third authentication unit (C) 303. The authentication request unit 400 has a function of updating the authentication state hold buffer 500 on the basis of the authentication results of the first authentication unit (A) 301, second authentication unit (B) 302 and third authentication unit (C) 303.

The authentication state hold buffer 500 holds the authentication results of the first authentication process (A), second authentication process (B) and third authentication process (C). If the first authentication process (A) is successfully completed, that is, if the authenticity of the password that is input by the user is confirmed, the authentication request unit 400 sets a completion-of-authentication flag “1” in an entry of the authentication state hold buffer 500, which corresponds to the first authentication process (A). If the second authentication process (B) is successfully completed, that is, if the authenticity of the biometric information of the user is confirmed, the authentication request unit 400 sets a completion-of-authentication flag “1” in an entry of the authentication state hold buffer 500, which corresponds to the second authentication process (B). If the third authentication process (C) is successfully completed, that is, if the authenticity of the user's handwritten signature is confirmed, the authentication request unit 400 sets a completion-of-authentication flag “1” in an entry of the authentication state hold buffer 500, which corresponds to the third authentication process (C).

The necessary-number-of-authentication-processes table 600 stores number-of-authentication-processes information. The number-of-authentication-processes information is indicative of the number of authentication processes, which must be successfully completed in order to use the computer main body 11, for each of lengths of an elapsed time from a time point of the end of the last use of the computer 10, i.e. the computer main body 11, to a time point of the issuance of a request for the next use of the computer 10, i.e. the computer main body 11. The time point of the end of the last use of the computer main body 11 refers to, for example, a time point of the last power-off of the computer main body 11 or a time point of the last logoff. The longer the elapsed time, the greater the number of authentication processes which must be successfully completed.

For example, if the elapsed time from the last logoff to the issuance of a request for the next logon is within 10 seconds, the number of authentication processes which must be successfully completed is one. If the elapsed time from the last logoff to the issuance of a request for the next logon is in a range between 11 seconds and 60 seconds, the number of authentication processes which must be successfully completed is two. If the elapsed time from the last logoff to the issuance of a request for the next logon is 61 seconds or more, the number of authentication processes which must be successfully completed is three. In this manner, the number of authentication processes which must be successfully completed varies in accordance with the elapsed time.

The use permission determination unit 700 determines, when the content of the authentication state hold buffer 500 is updated, whether the user is to be permitted to use the computer 10 or not, by using the content of the authentication state hold buffer 500, the necessary-number-of-authentication-processes table 600 and the time-measuring unit 800. Specifically, the time-measuring unit 800 measures, with use of the RTC 201, the elapsed time from the time point of the end of the last use of the computer main body 11 to the present time point, i.e. the elapsed time from the time point of the end of the last use of the computer main body 11 to the issuance of a request for the next use of the computer main body 11. The use permission determination unit 700 acquires the necessary number of authentication processes, which corresponds to the measured elapsed time, from the necessary-number-of-authentication-processes table 600, and determines whether the number of successfully completed authentication processes of the above-described three authentication processes has reached the acquired necessary number of authentication processes.

The end-of-use notice unit 900 executes preparation for the next authentication when the user has finished the use of the computer 10. Specifically, the end-of-use notice unit 900 executes, at the time of logoff or at the time of powering off the computer 10, a process of resetting the time-measuring unit 800, a process of clearing the authentication state hold buffer 500, and a process of informing the authentication request unit 400 of the end of use of the computer 10.

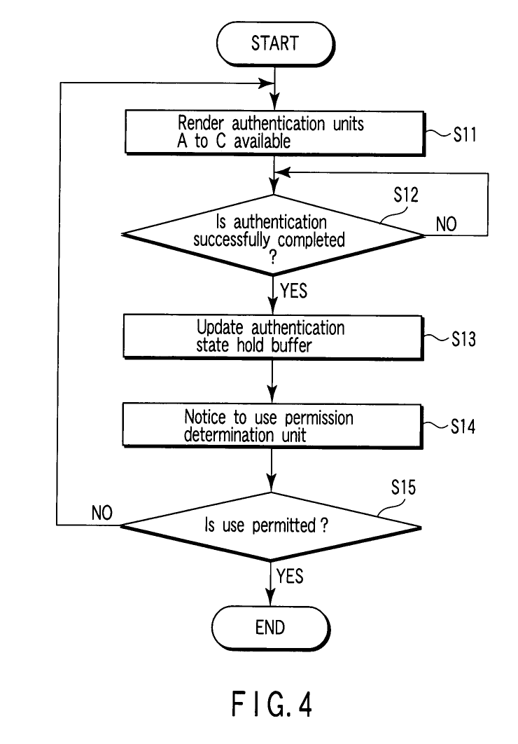

FIG. 4 is a flow chart illustrating an example of the procedure of the process which is executed by the authentication request unit 400.

When the use of the computer 11 is requested, that is, when the computer 10 is powered on or when the OS is to be logged on, the authentication control program is started. When the authentication control program is started, the authentication request unit 400 executes the following process.

To start with, the authentication request unit 400 renders available all the first authentication unit (A) 301, second authentication unit (B) 302 and third authentication unit (C) 303, thereby making usable an arbitrary one of the first authentication unit (A) 301, second authentication unit (B) 302 and third authentication unit (C) 303 (block S11).

The authentication request unit 400 waits for a successful authentication notice from each of the first authentication unit (A) 301, second authentication unit (B) 302 and third authentication unit (C) 303. If a successful authentication notice is issued from any one of the first authentication unit (A) 301, second authentication unit (B) 302 and third authentication unit (C) 303 (YES in block S12), the authentication request unit 400 sets the completion-of-authentication flag “1” in the entry in the authentication state hold buffer 500, which corresponds to the successfully completed authentication process, thereby updating the content of the authentication state hold buffer 500 (block S13). Then, the authentication request unit 400 informs the use permission determination unit 700 that the content of the authentication state hold buffer 500 has been updated, and requests the use permission determination unit 700 to execute the use permission determination process (block S14).

The authentication request unit 400 determines whether the use permission determination unit 700 has permitted the user to use the computer 10 (block S15). If the use of the computer 10 has been permitted (YES in block S15), the authentication request unit 400 completes the present process.

On the other hand, if the use of the computer 10 is not permitted (NO in block S15), the authentication request unit 400 waits once again for a successful authentication notice from each of the first authentication unit (A) 301, second authentication unit (B) 302 and third authentication unit (C) 303.

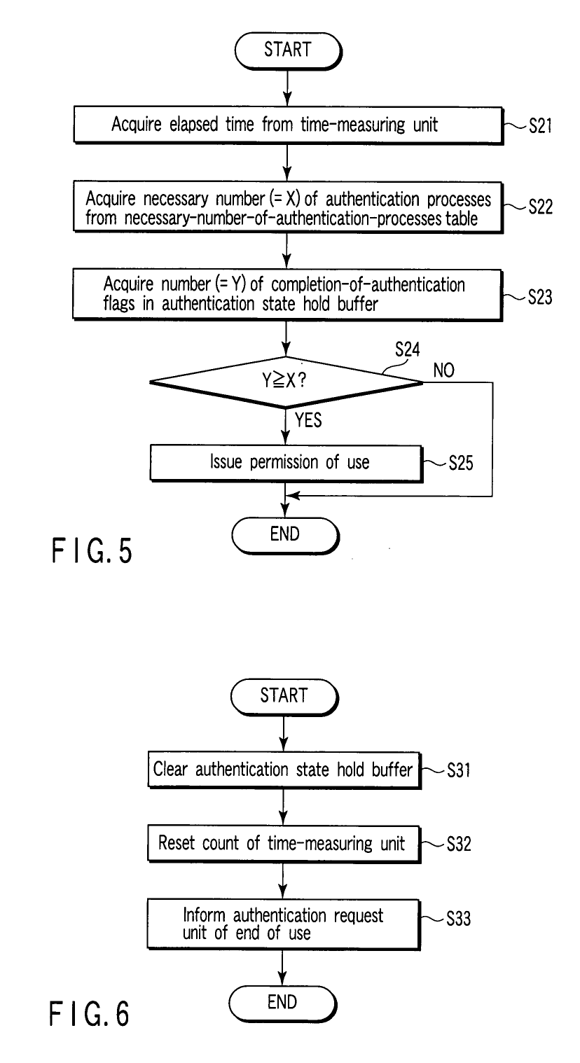

FIG. 5 is a flow chart illustrating an example of the procedure of the use permission determination process which is executed by the use permission determination unit 700.

When the authentication control program has been started, the use permission determination unit 700 first acquires from the time-measuring unit 800 the elapsed time from the time point of the end of the last use of the computer 10 to the present time point (block S21). Then, the use permission determination unit 700 acquires the necessary number X of authentication processes, which corresponds to the acquired elapsed time, from the necessary-number-of-authentication-processes table 600 (block S22).

If the execution of the use permission determination process is requested by the authentication request unit 400, the use permission determination unit 700 refers to the authentication state hold buffer 500 and counts the number of authentication processes for which the completion-of-authentication flag is set, i.e. the number Y of successfully completed authentication processes (block S23). Then, the use permission determination unit 700 compares the number X and number Y, and determines whether Y≧X (block S24).

If Y≧X (YES in block S24), the use permission determination unit 700 determines that the user has passed the necessary number of authentication processes (i.e. the necessary number of authentication processes have successfully been completed), and permits the use of the computer 10 (block S25). In block S25, the use permission determination unit 700 executes a process of booting up the OS, or a process of permitting the user to log on to the OS.

FIG. 6 is a flow chart illustrating an example of the procedure of the process which is executed by the end-of-use notice unit 900.

When the use of the computer 10 has ended (i.e. when the logoff has been executed or when the computer 10 has been powered off), the end-of-use notice unit 900 executes various preparatory processes, as described below, for the next authentication process.

The end-of-use notice unit 900 clears the content of the authentication state hold buffer 500, and restores the status flag, which corresponds to each authentication process, to “0” which is indicative of incompletion of authentication (block S31). Subsequently, the end-of-use notice unit 900 resets the current value of the time-measuring unit 800 to zero (block S32). The end-of-use notice unit 900 then informs the authentication request unit 400 of the end of the use of the computer 10, and puts the authentication request unit 400 into the authentication wait state (block S33).

As has been described above, in the present embodiment, a plurality of kinds of authentication functions are provided, and the number of authentication processes, which must be successfully completed in order to use the computer 10, is automatically varied in accordance with the elapsed time from the time point of the end of the last use of the computer 10 to the time point of the next use of the computer 10. For example, in the case where logon is requested once again immediately after logoff from the operating system, it is highly possible that the user who requests the logon is an authorized user. Thus, when the elapsed time from the logoff is short, the necessary number of authentication processes is reduced, and thereby the usability can be enhanced. In addition, in the case where the elapsed time from logoff is short, it is highly possible that the authorized user is present near the computer 10. Thus, even if the necessary number of authentication processes is reduced, the security level is not greatly degraded.

Therefore, according to the computer 10 of the present embodiment, the security level can be increased without deteriorating the usability.

The authentication control process of this embodiment is all realized by software. Therefore, simply by installing a program for executing the procedure of the authentication control process in an ordinary computer through a computer-readable storage medium, the same advantageous effect as in the present embodiment can advantageously be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a plurality of authentication units which execute a plurality of mutually different kinds of authentication processes;
a time-measuring unit which measures an elapsed time from a time point of an end of last use of the main body to issuance of a request for use of the main body; and
a use permission determination unit which determines whether a number of successfully completed authentication processes of the plural kinds of authentication processes has reached a predetermined number which varies in accordance with the elapsed time measured by the time-measuring unit, and permits the use of the main body when the number of successfully completed authentication processes has reached the predetermined number.

2. The information processing apparatus according to claim 1, further comprising a table which stores number-of-authentication-processes information, which is indicative of a number of authentication processes which must be successfully completed in order to use the main body, for each of lengths of the elapsed time,
wherein the use permission determination unit acquires from the table a number of authentication processes which corresponds to the elapsed time measured by the time-measuring unit, and determines whether the number of successfully completed authentication processes of the plural kinds of authentication processes has reached the acquired number of authentication processes.

3. The information processing apparatus according to claim 1, wherein the plural kinds of authentication processes include at least a first authentication process of verifying a password which is input by typing by a user, and a second authentication process of verifying biometric information of the user.

4. The information processing apparatus according to claim 1, wherein the use permission determination unit permits a user to log on to an operating system, thereby to permit the use of the main body, when the predetermined number of authentication processes is successfully completed,

5. The information processing apparatus according to claim 1, wherein the use permission determination unit boots up an operating system, thereby to permit the use of the main body, when the predetermined number of authentication processes is successfully completed.

6. An authentication control method for restricting use of an information processing apparatus which is capable of executing a plurality of kinds of authentication processes, comprising:
measuring an elapsed time from a time point of an end of last use of the information processing apparatus to issuance of a request for use of the information processing apparatus;
determining whether a number of successfully completed authentication processes of the plural kinds of authentication processes has reached a predetermined number which varies in accordance with the measured elapsed time; and
permitting the use of the information processing apparatus if the number of successfully completed authentication processes has reached the predetermined number.

7. The authentication control method according to claim 6, wherein the information processing apparatus includes a table which stores number-of-authentication-processes information, which is indicative of a number of authentication processes which must be successfully completed in order to use the main body, for each of lengths of the elapsed time, and
said determining includes acquiring from the table a number of authentication processes which corresponds to the measured elapsed time, and determining whether the number of successfully completed authentication processes of the plural kinds of authentication processes has reached the acquired number of authentication processes.

8. The authentication control method according to claim 6, wherein the plural kinds of authentication processes include at least a first authentication process of verifying a password which is input by typing by a user, and a second authentication process of verifying biometric information of the user.

9. A program which is stored in a computer-readable media and causes a computer, which is capable of executing a plurality of kinds of authentication processes, to execute a process of restricting use of the computer, comprising:
causing the computer to execute a process of measuring an elapsed time from a time point of an end of last use of the computer to issuance of a request for use of the computer;
causing the computer to execute a process of determining whether a number of successfully completed authentication processes of the plural kinds of authentication processes has reached a predetermined number which varies in accordance with the measured elapsed time; and
causing the computer to execute a process of permitting the use of the computer if the number of successfully completed authentication processes has reached the predetermined number.

10. The program according to claim 9, wherein the computer includes a table which stores number-of-authentication-processes information, which is indicative of a number of authentication processes which must be successfully completed in order to use the computer, for each of lengths of the elapsed time, and
said causing the computer to execute the process of determining includes causing the computer to execute a process of acquiring from the table a number of authentication processes which corresponds to the measured elapsed time, and determining whether the number of successfully completed authentication processes of the plural kinds of authentication processes has reached the acquired number of authentication processes.

11. The program according to claim 9, wherein the plural kinds of authentication processes include at least a first authentication process of verifying a password which is input by typing by a user, and a second authentication process of verifying biometric information of the user.
